(19) United States
(12) Patent Application Publication
(10) Pub. No.: US 2024/0054612 A1
(43) Pub. Date: Feb. 15, 2024

(54) IINFORMATION PROCESSING APPARATUS, INFORMATION PROCESSING METHOD, AND PROGRAM

(71) Applicant: FUJIFILM CORPORATION, Tokyo (JP)

(72) Inventor: Kazuchika IWAMI, Kanagawa (JP)

(21) Appl. No.: 18/493,800

(22) Filed: Oct. 24, 2023

Related U.S. Application Data
(63) Continuation of application No. PCT/JP2022/017867, filed on Apr. 14, 2022.

(30) Foreign Application Priority Data
May 11, 2021 (JP) 2021-080588

(51) Int. Cl. G06T 5/50; G01S 17/89; G01S 17/86; G06T 7/13

(52) U.S. Cl. CPC G06T 5/50; G01S 17/89; G01S 17/86; G06T 7/13; G06T 2207/20212; G06T 2207/10032; G06T 2207/10028

(57) ABSTRACT

This information processing apparatus is an information processing apparatus that processes point cloud data output from a measurement apparatus including an external sensor that repeatedly scans a surrounding space to acquire segmented point cloud data for each scan, and an internal sensor that detects a posture to acquire posture detection data, and the information processing apparatus includes at least one processor. The processor is configured to generate combined point cloud data by executing combination processing using a plurality of pieces of the segmented point cloud data acquired in a period during which the posture detection data satisfies an allowable condition, among a plurality of pieces of the segmented point cloud data acquired at different acquisition times by the external sensor.

### CROSS-REFERENCE TO RELATED APPLICATIONS

This application is a continuation application of International Application No. PCT/JP2022/017867, filed Apr. 14, 2022, the disclosure of which is incorporated herein by reference in its entirety. Further, this application claims priority from Japanese Patent Application No. 2021-080588, filed on May 11, 2021, the disclosure of which is incorporated herein by reference in its entirety.

### BACKGROUND

### 1. Technical Field

A technique of the present disclosure relates to an information processing apparatus, an information processing method, and a program.

### 2. Description of the Related Art

There is known a moving object system that has a measurement apparatus, such as light detection and ranging (LiDAR), mounted on a moving object to acquire point cloud data representing coordinates of a surrounding structure. In the moving object system, a surrounding space is repeatedly scanned by the measurement apparatus to acquire point cloud data for each scan, and a plurality of pieces of acquired point cloud data are combined, whereby map data having three-dimensional information is generated.

JP2016-189184A describes adjustment of point cloud data following a posture or the like of LiDAR. The adjustment of the point cloud data is performed when combining point cloud data before and after change in posture.

### SUMMARY

In a case where the change in posture of the LiDAR is slight, as described in JP2016-189184A, the point cloud data before and after the change in posture can be combined by adjusting the point cloud data.

Note that, in a case where the change in posture of LiDAR is large, point cloud data that cannot be combined is acquired before and after the change in posture, causing an information processing apparatus for use in combination processing to fail to combine point cloud data before and after the change in posture.

The technique of the present disclosure provides an information processing apparatus, an information processing method, and a program capable of suppressing failure in combining a plurality of pieces of point cloud data.

An information processing apparatus of the present disclosure is an information processing apparatus that processes segmented point cloud data output from a measurement apparatus including an external sensor that repeatedly scans a surrounding space to acquire the segmented point cloud data for each scan, and an internal sensor that detects a posture to acquire posture detection data, the information processing apparatus comprising at least one processor, in which the processor is configured to generate combined point cloud data by executing combination processing using a plurality of pieces of the segmented point cloud data acquired in a period during which the posture detection data satisfies an allowable condition, among a plurality of pieces of the segmented point cloud data acquired at different acquisition times by the external sensor.

It is preferable that the internal sensor is an inertial measurement sensor having at least one of an acceleration sensor or an angular velocity sensor, and the posture detection data includes an output value of the acceleration sensor or of the angular velocity sensor.

It is preferable that the allowable condition is that an absolute value of the output value of the acceleration sensor or of the angular velocity sensor is less than a first threshold value.

It is preferable that the allowable condition is that a temporal change amount of the output value of the acceleration sensor or of the angular velocity sensor is less than a second threshold value.

It is preferable that the external sensor includes a first sensor that acquires first segmented point cloud data by scanning a space with laser light, and a second sensor that acquires second segmented point cloud data based on a plurality of camera images, and the segmented point cloud data includes the first segmented point cloud data and the second segmented point cloud data.

It is preferable that the processor is configured to generate combined segmented point cloud data by combining the first segmented point cloud data and the second segmented point cloud data, and generate the combined point cloud data by combining a plurality of pieces of the generated combined segmented point cloud data.

It is preferable that the processor is configured to generate the combined segmented point cloud data by partially selecting data from each of the first segmented point cloud data and the second segmented point cloud data based on a feature of a structure shown in at least one camera image among the plurality of camera images.

It is preferable that the measurement apparatus is provided in an unmanned moving object.

An information processing method of the present disclosure is an information processing method that processes segmented point cloud data output from a measurement apparatus including an external sensor that repeatedly scans a surrounding space to acquire the segmented point cloud data for each scan, and an internal sensor that detects a posture to acquire posture detection data, the information processing method comprising generating combined point cloud data by executing combination processing using a plurality of pieces of the segmented point cloud data acquired in a period during which the posture detection data satisfies an allowable condition, among a plurality of pieces of the segmented point cloud data acquired at different acquisition times by the external sensor.

A program of the present disclosure is a program that causes a computer to execute processing on segmented point cloud data output from a measurement apparatus including an external sensor that repeatedly scans a surrounding space to acquire the segmented point cloud data for each scan, and an internal sensor that detects a posture to acquire posture detection data, the program causing the computer to execute combination processing of generating combined point cloud data using a plurality of pieces of the segmented point cloud data acquired in a period during which the posture detection data satisfies an allowable condition, among a plurality of pieces of the segmented point cloud data acquired at different acquisition times by the external sensor.

### BRIEF DESCRIPTION OF THE DRAWINGS

Exemplary embodiments according to the technique of the present disclosure will be described in detail based on the following figures, wherein:

FIG. 1 is a schematic configuration diagram showing an example of an overall configuration of a moving object system according to a first embodiment,

FIG. 2 is a schematic perspective view showing an example of detection axes of an acceleration sensor and an angular velocity sensor,

FIG. 3 is a block diagram showing an example of a hardware configuration of the moving object system,

FIG. 4 is a conceptual diagram showing an example of a path along which a moving object moves,

FIG. 5 is a conceptual diagram showing an example of segmented point cloud data,

FIG. 6 is a conceptual diagram showing an example of combination processing of a plurality of pieces of segmented point cloud data,

FIG. 7 is a conceptual diagram showing an example of a period during which an allowable condition is not satisfied,

FIG. 8 is a flowchart illustrating an example of a flow of combination processing according to the first embodiment,

FIG. 9 is a schematic configuration diagram showing an example of an overall configuration of a moving object system according to a second embodiment,

FIG. 10 is a block diagram showing an example of a hardware configuration of the moving object system according to the second embodiment,

FIG. 11 is a conceptual diagram showing an example of an acquisition method of second segmented point cloud data,

FIG. 12 is a block diagram showing an example of a combination processing unit according to the second embodiment,

FIG. 13 is a conceptual diagram showing an example of second combined segmented point cloud data,

FIG. 14 is a flowchart illustrating an example of a flow of combination processing according to the second embodiment, and

FIG. 15 is a conceptual diagram showing an example of a period during which an allowable condition is not satisfied, in the second embodiment.

### DETAILED DESCRIPTION

Hereinafter, an example of an information processing apparatus, an information processing method, and a program according to the technique of the present disclosure will be described with reference to the accompanying drawings.

First, terms that are used in the following description will be described.

CPU is an abbreviation for “central processing unit”. NVM is an abbreviation for “non-volatile memory”. RAM is an abbreviation for “random-access memory”. IC is an abbreviation for “integrated circuit”. ASIC is an abbreviation for “application-specific integrated circuit”. PLD is an abbreviation for “programmable logic device”. FPGA is an abbreviation for “field-programmable gate array”. SoC is an abbreviation for “system on a chip”. SSD is an abbreviation for “solid-state drive”. USB is an abbreviation for “universal serial bus”. HDD is an abbreviation for “hard-disk drive”. EEPROM is an abbreviation for “electrically erasable programmable read-only memory”. EL is an abbreviation for “electroluminescence”. OF is an abbreviation for “interface”. CMOS is an abbreviation for “complementary metal-oxide-semiconductor”. SLAM is an abbreviation for “simultaneous localization and mapping”.

### First Embodiment

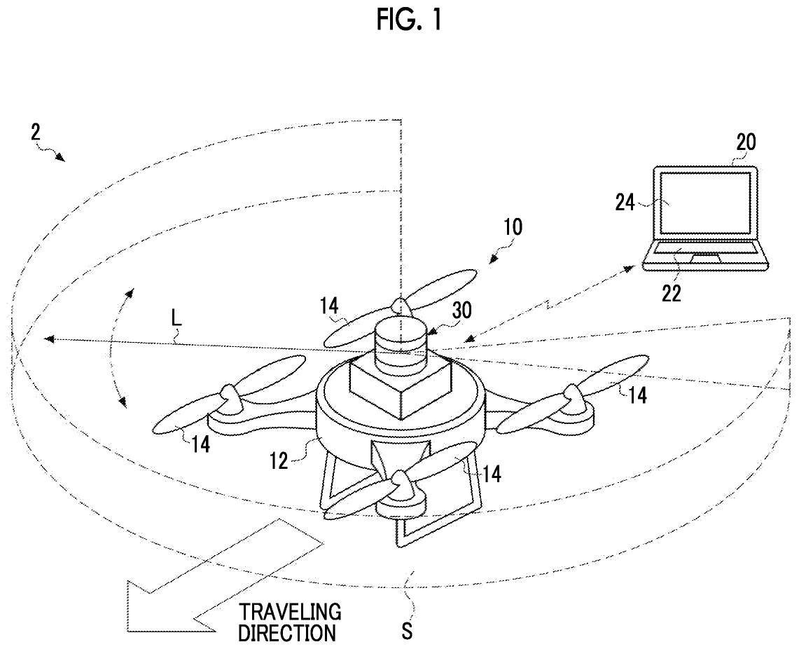

As shown in FIG. 1 as an example, a moving object system 2 is configured with a moving object 10 and an information processing apparatus 20. A measurement apparatus 30 is mounted on the moving object 10. In the present embodiment, the moving object 10 is an unmanned flying object (so-called drone) as an example of an unmanned moving object. The moving object 10 and the information processing apparatus 20 perform communication in a wireless manner.

The moving object 10 comprises a main body 12 and four propellers 14 as a drive device. The moving object 10 can fly along any path in a three-dimensional space by controlling a rotation direction of each of the four propellers 14.

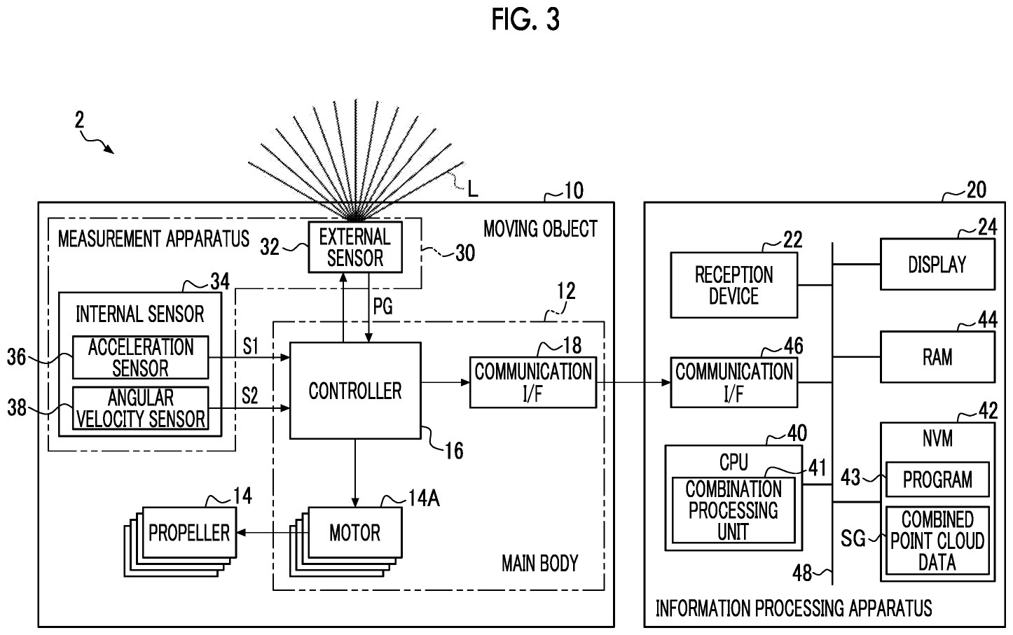

The measurement apparatus 30 is attached to, for example, an upper portion of the main body 12. The measurement apparatus 30 incorporates an external sensor 32 and an internal sensor 34 (see FIG. 3). The external sensor 32 is a sensor that senses an external environment of the moving object 10. In the present embodiment, the external sensor 32 is LiDAR and scans a surrounding space by emitting a pulsed laser beam L to the surroundings. The laser beam L is, for example, visible light or infrared rays.

The external sensor 32 receives reflected light of the laser beam L reflected from a structure in the surrounding space and measures a time until the reflected light is received after the laser beam L is emitted, thereby obtaining a distance to a reflection point of the laser beam L in the structure. The external sensor 32 outputs point cloud data representing position information (three-dimensional coordinates) of a plurality of reflection points each time the external sensor 32 scans the surrounding space. The point cloud data is also referred to as a point cloud. The point cloud data is, for example, data expressed by three-dimensional Cartesian coordinates.

The external sensor 32 emits the laser beam L, for example, in a visual field range S of 135 degrees right and left (270 degrees in total) and 15 degrees up and down (30 degrees in total) with a traveling direction of the moving object 10 as a reference. The external sensor 32 emits the laser beam L in the entire visual field range S while changing an angle by 0.25 degrees in any direction of right and left or up and down. The external sensor 32 repeatedly scans the visual field range S and outputs point cloud data for each scan. The point cloud data output from the external sensor 32 for each scan is hereinafter referred to as segmented point cloud data PG.

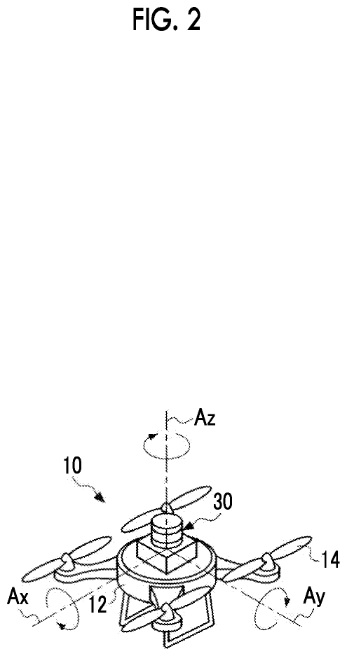

The internal sensor 34 includes an acceleration sensor 36 and an angular velocity sensor 38 (see FIG. 3). For example, the acceleration sensor 36 detects accelerations applied in directions of an X axis Ax, a Y axis Ay, and a Z axis Az perpendicular to one another as shown in FIG. 2. For example, the angular velocity sensor 38 detects angular velocities applied around respective axes of the X axis Ax, the Y axis Ay, and the Z axis Az (that is, respective rotation directions of a roll, a pitch, and a yaw) as shown in FIG. 2. That is, the internal sensor 34 is a six-axis inertial measurement sensor.

The internal sensor 34 outputs posture detection data representing a posture of the moving object 10. The posture detection data includes an output value S1 of the acceleration sensor 36 and an output value S2 of the angular velocity sensor 38. While the output value of the acceleration sensor 36 includes acceleration detection values in the three axis directions of the X axis Ax, the Y axis Ay, and the Z axis Az, in the present embodiment, for simplification, the acceleration detection values are collectively referred to as the output value S1. Similarly, while the output value of the angular velocity sensor 38 includes angular velocity detection values in the three rotation directions of the roll, the pitch, and the yaw, in the present embodiment, for simplification, the angular velocity detection values are collectively referred to as the output value S2.

The moving object 10 autonomously flies along a specified path while estimating a self position based on data acquired by the external sensor 32 and the internal sensor 34. The moving object system 2 simultaneously performs self position estimation of the moving object 10 and environmental map generation using the SLAM technique, for example.

The information processing apparatus 20 is, for example, a personal computer, and comprises a reception device 22 and a display 24. The reception device 22 is, for example, a keyboard, a mouse, and a touch panel. The information processing apparatus 20 generates an environmental map by combining a plurality of pieces of segmented point cloud data PG output from the measurement apparatus 30 of the moving object 10. The information processing apparatus 20 displays the generated environmental map on the display 24.

As shown in FIG. 3 as an example, the main body 12 of the moving object 10 is provided with a controller 16, a communication I/F 18, and a motor 14A. The controller 16 is configured with, for example, an IC chip. The controller 16 controls the flight of the moving object 10 by performing drive control of the motor 14A provided for each of the four propellers 14. The controller 16 controls a scan operation of the laser beam L by the external sensor 32 and receives the segmented point cloud data PG output from the external sensor 32.

The controller 16 receives the posture detection data (the output value S1 of the acceleration sensor 36 and the output value S2 of the angular velocity sensor 38) output from the internal sensor 34. The controller 16 transmits the received segmented point cloud data PG and posture detection data to the information processing apparatus 20 via the communication I/F 18 in a wireless manner.

The information processing apparatus 20 comprises a CPU 40, an NVM 42, a RAM 44, and a communication OF 46 in addition to the reception device 22 and the display 24. In addition to the reception device 22 and the display 24, the CPU 40, the NVM 42, the RAM 44, and the communication I/F 46 are connected by a bus 48. The information processing apparatus 20 is an example of a “computer” according to the technique of the present disclosure. The CPU 40 is an example of a “processor” according to the technique of the present disclosure.

The NVM 42 stores various kinds of data. Here, examples of the NVM 42 include various nonvolatile storage devices, such as an EEPROM, an SSD, and/or an HDD. The RAM 44 temporarily stores various kinds of information and is used as a work memory. An example of the RAM 44 is a DRAM or a SRAM.

A program 43 is stored in the NVM 42. The CPU 40 reads out the program 43 from the NVM 42 and executes the read-out program 43 on the RAM 44. The CPU 40 controls the entire moving object system 2 including the information processing apparatus 20 by executing processing according to the program 43. Furthermore, the CPU 40 functions as a combination processing unit 41 by executing processing based on the program 43.

The communication OF 46 performs communication with the communication OF 18 of the moving object 10 in a wireless manner and receives the segmented point cloud data PG and the posture detection data output from the moving object 10 for each scan. That is, the information processing apparatus 20 receives a plurality of pieces of segmented point cloud data PG acquired at different acquisition times by the external sensor 32 and the posture detection data corresponding to each piece of segmented point cloud data PG.

The combination processing unit 41 generates combined point cloud data SG by executing combination processing of combining a plurality of pieces of segmented point cloud data PG received from the moving object 10. The combined point cloud data SG corresponds to the above-described environmental map. The combined point cloud data SG generated by the combination processing unit 41 is stored in the NVM 42. The combined point cloud data SG stored in the NVM 42 is displayed as the environmental map on the display 24.

In executing the combination processing, the combination processing unit 41 generates the combined point cloud data SG by executing the combination processing using a plurality of pieces of segmented point cloud data PG acquired in a period during which the posture detection data satisfies an allowable condition, among a plurality of pieces of segmented point cloud data PG acquired from the moving object 10.

For example, the allowable condition is that an absolute value of the output value S1 of the acceleration sensor 36 is less than a threshold value TH1. This means that, for example, the acceleration detection value in at least one axis direction among the acceleration detection values in the three axis directions included in the output value S1 of the acceleration sensor 36 is less than the threshold value TH1. In this case, the combination processing unit 41 generates the combined point cloud data SG by executing the combination processing using a plurality of pieces of segmented point cloud data PG acquired in a period during which the absolute value of the output value S1 of the acceleration sensor 36 is less than the threshold value TH1. The threshold value TH1 is an example of a “first threshold value” according to the technique of the present disclosure.

The allowable condition may be that an absolute value of the output value S2 of the angular velocity sensor 38 is less than a threshold value. This means that, for example, the angular velocity detection value in at least one rotation direction among the angular velocity detection values in the three rotation directions included in the output value S2 of the angular velocity sensor 38 is less than the threshold value. In this case, the combination processing unit 41 generates the combined point cloud data SG by executing the combination processing using a plurality of pieces of segmented point cloud data PG acquired in a period during which the absolute value of the output value S2 of the angular velocity sensor 38 is less than the threshold value.

The allowable condition may be that a temporal change amount of the output value S1 of the acceleration sensor 36 is less than a threshold value TH2. This means that, for example, the temporal change amount of the acceleration detection value in at least one axis direction among the acceleration detection values in the three axis directions included in the output value S1 of the acceleration sensor 36 is less than the threshold value TH2. The temporal change amount is an absolute value of a change amount per unit time (for example, one second). In this case, the combination processing unit 41 generates the combined point cloud data SG by executing the combination processing using a plurality of pieces of segmented point cloud data PG acquired in a period during which the temporal change amount of the output value S1 of the acceleration sensor 36 is less than the threshold value TH2. The threshold value TH2 is an example of a “second threshold value” according to the technique of the present disclosure. The threshold value TH2 is set to, for example, a value 1.5 times greater than the temporal change amount of the output value S1 in a stationary state in which the moving object 10 is in a stationary posture.

The allowable condition may be that a temporal change amount of the output value S2 of the angular velocity sensor 38 is less than a threshold value. This means that, for example, the temporal change amount of the angular velocity detection value in at least one rotation direction among the angular velocity detection values in the three rotation directions included in the output value S2 of the angular velocity sensor 38 is less than the threshold value. The temporal change amount is an absolute value of a change amount per unit time (for example, one second). In this case, the combination processing unit 41 generates the combined point cloud data SG by executing the combination processing using a plurality of pieces of segmented point cloud data PG acquired in a period during which the temporal change amount of the output value S2 of the angular velocity sensor 38 is less than the threshold value.

The allowable condition may be a condition for a combination of two or more values of the output value S1 of the acceleration sensor 36, the output value S2 of the angular velocity sensor 38, the temporal change amount of the output value S1, and the temporal change amount of the output value S2.

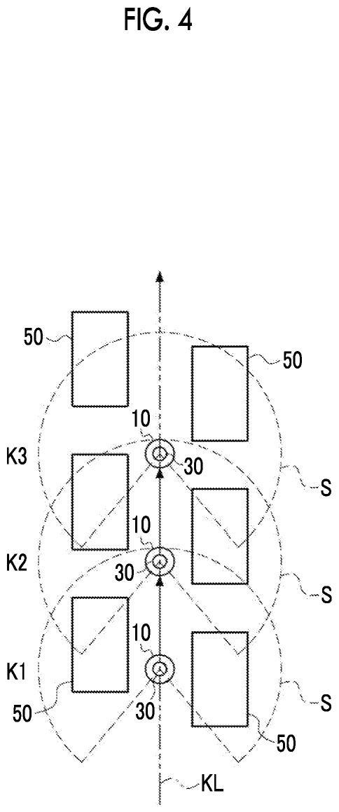

As shown in FIG. 4 as an example, the moving object 10 moves along a predetermined path KL. A plurality of structures 50 are present around the path KL along which the moving object 10 moves. The moving object 10 repeatedly scans the surrounding space using the external sensor 32 of the measurement apparatus 30 while moving along the path KL, and acquires and outputs the segmented point cloud data PG for each scan. That is, the moving object 10 scans the entire space by scanning the entire surrounding space of the path KL in units divided spatially and temporally. In the example shown in FIG. 4, the moving object 10 performs scanning with the laser beam L in the visual field range S at each of three positions K1 to K3.

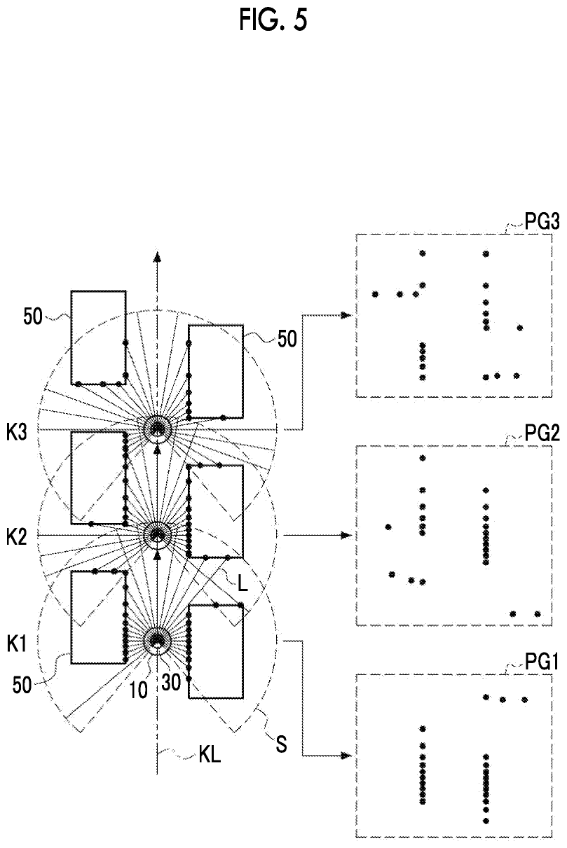

As shown in FIG. 5 as an example, the moving object 10 acquires the segmented point cloud data PG1 to PG3 at the positions K1 to K3 with the external sensor 32 and outputs the segmented point cloud data PG1 to PG3. Each point included in the segmented point cloud data PG1 to PG3 represents a position (three-dimensional coordinates) of a reflection point of the laser beam L by the structure 50.

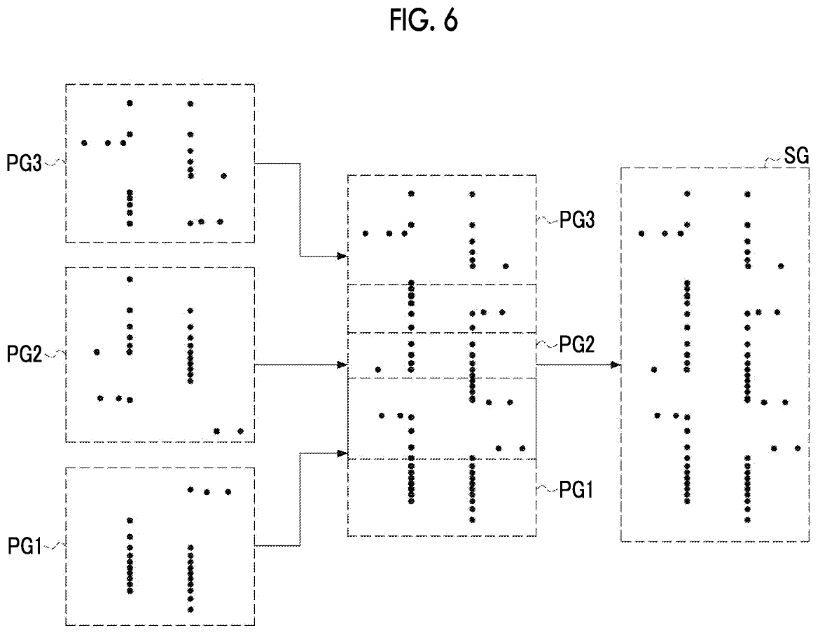

As shown in FIG. 6 as an example, the combination processing unit 41 generates the combined point cloud data SG by executing the combination processing after aligning such that the segmented point cloud data PG1 to PG3 match one another. The combination processing unit 41 executes the combination processing using a technique for use in SLAM, for example.

While flying along the path KL, the moving object 10 may flap in, for example, a gust of wind, and may be significantly changed in posture. In a case where the moving object 10 is significantly changed in posture while moving along the path KL, the visual field range S is significantly changed, so that it is not possible to perform matching between two pieces of segmented point cloud data PG before and after the change in posture, and the combination processing is likely to fail. For this reason, as described above, the combination processing unit 41 executes the combination processing using only the segmented point cloud data PG for which the posture detection data satisfies the allowable condition, without using the segmented point cloud data PG acquired in a period during which the posture detection data does not satisfy the allowable condition.

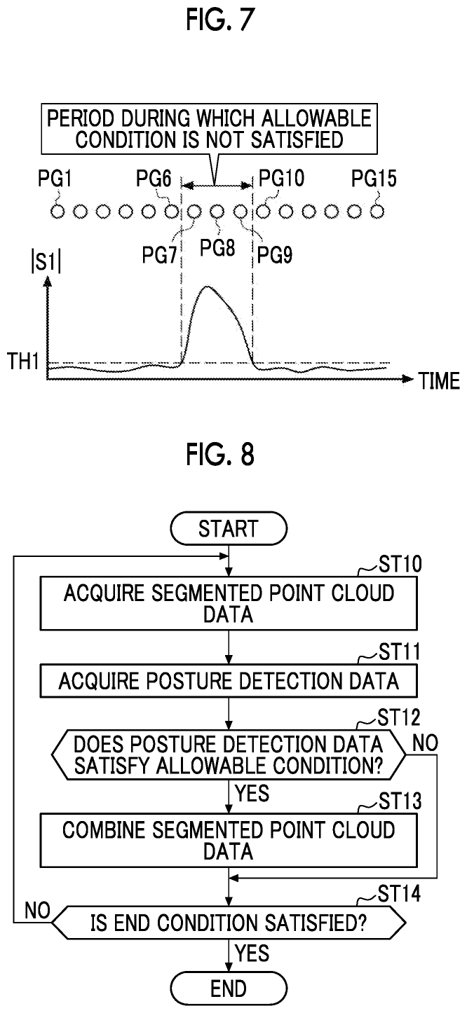

As shown in FIG. 7 as an example, segmented point cloud data PG1 to PG15 and the output value S1 of the acceleration sensor 36 are obtained, and in a case where the absolute value of the output value S1 in a period during which the segmented point cloud data PG7 to PG9 are obtained is less than the threshold value TH1, the combination processing unit 41 executes the combination processing using the segmented point cloud data PG1 to PG6 and PG10 to PG15.

The combination processing unit 41 may combine a plurality of pieces of acquired segmented point cloud data PG after a plurality of pieces of segmented point cloud data PG are acquired from the moving object 10 or may execute the combination processing each time the segmented point cloud data PG is acquired from the moving object 10.

Next, operations of the moving object system 2 will be described with reference to FIG. 8.

FIG. 8 is a flowchart illustrating an example of a flow of the combination processing that is executed by the combination processing unit 41. The flow of the combination processing shown in FIG. 8 is an example of an “information processing method” according to the technique of the present disclosure.

FIG. 8 shows an example where the combination processing unit 41 executes the combination processing each time the segmented point cloud data PG is acquired from the moving object 10. Here, it is a prerequisite that the moving object 10 repeatedly scans the surrounding space using the external sensor 32 and outputs the segmented point cloud data PG to the information processing apparatus 20 for each scan.

In the combination processing shown in FIG. 8, first, in Step ST10, the combination processing unit 41 acquires the segmented point cloud data PG output from the moving object 10. After Step ST10, the combination processing proceeds to Step ST11.

In Step ST11, the combination processing unit 41 acquires the above-described posture detection data corresponding to the segmented point cloud data PG acquired in Step ST10, from the moving object 10. After Step ST11, the combination processing proceeds to Step ST12.

In Step ST12, the combination processing unit 41 determines whether or not the posture detection data acquired in Step ST11 satisfies the above-described allowable condition. In Step ST12, in a case where the posture detection data satisfies the allowable condition, an affirmative determination is made, and the combination processing proceeds to Step ST13. In Step ST12, in a case where the posture detection data does not satisfy the allowable condition, a negative determination is made, and the combination processing proceeds to Step ST14.

In Step ST13, the combination processing unit 41 executes the above-described combination processing. Specifically, the combination processing unit 41 executes the combination processing of combining the segmented point cloud data PG acquired by a previous scan and the segmented point cloud data PG acquired by a present scan. After Step ST13, the combination processing proceeds to Step ST14.

In Step ST14, the combination processing unit 41 determines whether or not a condition (hereinafter, referred to as an “end condition”) for ending the combination processing is satisfied. An example of the end condition is a condition that an instruction to end the combination processing is received by the reception device 22. In Step ST14, in a case where the end condition is not satisfied, the negative determination is made, and the combination processing proceeds to Step ST10. In Step ST14, in a case where the end condition is satisfied, the affirmative determination is made, and the combination processing ends.

As described above, the information processing apparatus 20 executes the combination processing using a plurality of pieces of segmented point cloud data PG acquired in a period during which the posture detection data satisfies the allowable condition, among a plurality of pieces of segmented point cloud data PG acquired at different acquisition times by the external sensor 32, and generates the combined point cloud data SG. Thus, it is possible to suppress failure in combining a plurality of pieces of point cloud data.

### Second Embodiment

In the first embodiment, the external sensor 32 is configured with one sensor (LiDAR), but in a second embodiment, the external sensor 32 is configured with two sensors.

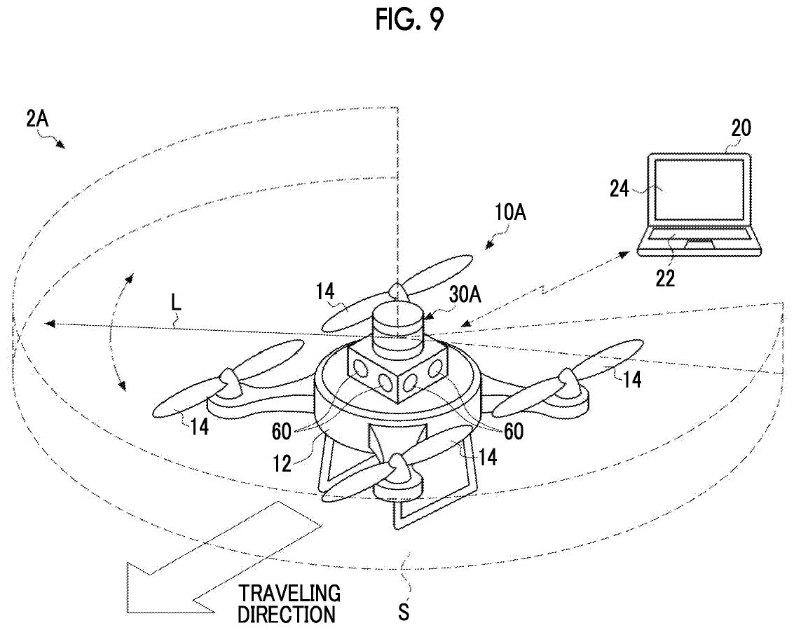

As shown in FIG. 9 as an example, in a moving object system 2A according to the second embodiment, a moving object 10A has a measurement apparatus 30A provided with a plurality of cameras 60. The cameras 60 are, for example, digital cameras having a CMOS type image sensor, and generate and output image data PD. The cameras 60 perform an imaging operation at a predetermined frame rate. The image data PD is an example of a “camera image” according to the technique of the present disclosure.

The plurality of cameras 60 image a range including the above-described visual field range S as a whole by each partially imaging the inside of the visual field range S. Imaging ranges of at least two adjacent cameras 60 among the plurality of cameras 60 overlap at least partially. That is, a parallax image composed of a pair of image data PD is acquired by two adjacent cameras 60.

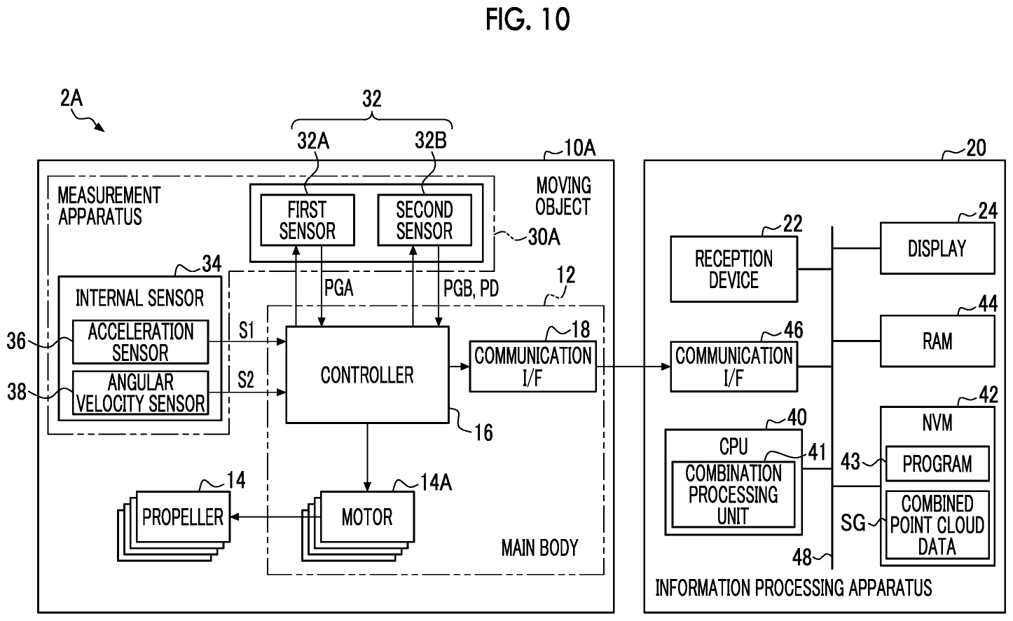

As shown in FIG. 10 as an example, an external sensor 32 of the present embodiment has a first sensor 32A and a second sensor 32B. The first sensor 32A is the LiDAR described in the first embodiment, and acquires segmented point cloud data PG by performing scanning with the laser beam L in the visual field range S. Hereinafter, the segmented point cloud data PG acquired by the first sensor 32A is referred to as first segmented point cloud data PGA.

The second sensor 32B has the plurality of cameras 60 described above and acquires segmented point cloud data PG based on a plurality of pieces of image data PD acquired by the plurality of cameras 60. Hereinafter, the segmented point cloud data PG acquired by the second sensor 32B is referred to as second segmented point cloud data PGB.

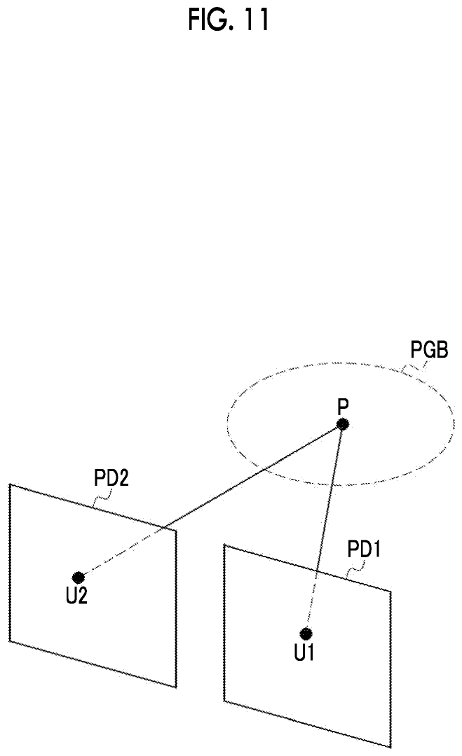

As shown in FIG. 11 as an example, the second sensor 32B extracts corresponding feature points U1 and U2 in a pair of image data PD1 and PD2. The second sensor 32B calculates three-dimensional coordinates of a point P represented by the corresponding feature points U1 and U2 based on a difference (parallax) between the positions of the extracted feature points U1 and U2 using the principle of triangulation. In the extraction of the feature points, known algorithms, such as SIFT, SURF, and AKAZE, can be used.

In FIG. 11, although only one feature point is shown in each of the image data PD1 and PD2, the second sensor 32B calculates three-dimensional coordinates of a plurality of points P by extracting a plurality of feature points from each of the image data PD1 and PD2. The second sensor 32B is a distance measurement sensor using a so-called stereo camera.

The second sensor 32B generates the second segmented point cloud data PGB by calculating three-dimensional coordinates of a plurality of points P in the visual field range S based on a plurality of pieces of image data PD acquired by the plurality of cameras 60.

Because the second sensor 32B using the stereo camera extracts a feature point corresponding to texture (pattern or the like) of a structure as a distance measurement target from the image data PD, distance measurement accuracy depends on the texture of the structure. For example, in the second sensor 32B, because it is difficult to acquire a feature point on a surface with no pattern or the like of the structure, it is not possible to perform distance measurement. In contrast, because the first sensor 32A using the LiDAR performs distance measurement based on reflected light of the laser beam L from the structure, distance measurement accuracy does not depend on the texture of the structure. For this reason, point cloud density of the second segmented point cloud data PGB generated by the second sensor 32B is made to be lower than point cloud density of the first segmented point cloud data PGA generated by the first sensor 32A.

On the other hand, because it is possible to accurately extract an edge portion of the structure as a feature point according to the image data PD, the second sensor 32B can perform distance measurement on the edge portion of the structure with high accuracy. In contrast, because measurement points by scanning with the laser beam L are discrete, the first sensor 32A cannot perform distance measurement on the edge portion of the structure with high accuracy.

That is, the first sensor 32A can accurately acquire the point cloud data on portions other than the edge portion of the structure, and the second sensor 32B can accurately acquire the point cloud data on the edge portion of the structure.

In the present embodiment, the CPU 40 outputs the first segmented point cloud data PGA and the second segmented point cloud data PGB to the information processing apparatus 20 via the communication OF 18. In the present embodiment, the CPU 40 outputs a plurality of pieces of image data PD acquired by the plurality of cameras 60 to the information processing apparatus 20 via the communication OF 18, in addition to the first segmented point cloud data PGA and the second segmented point cloud data PGB.

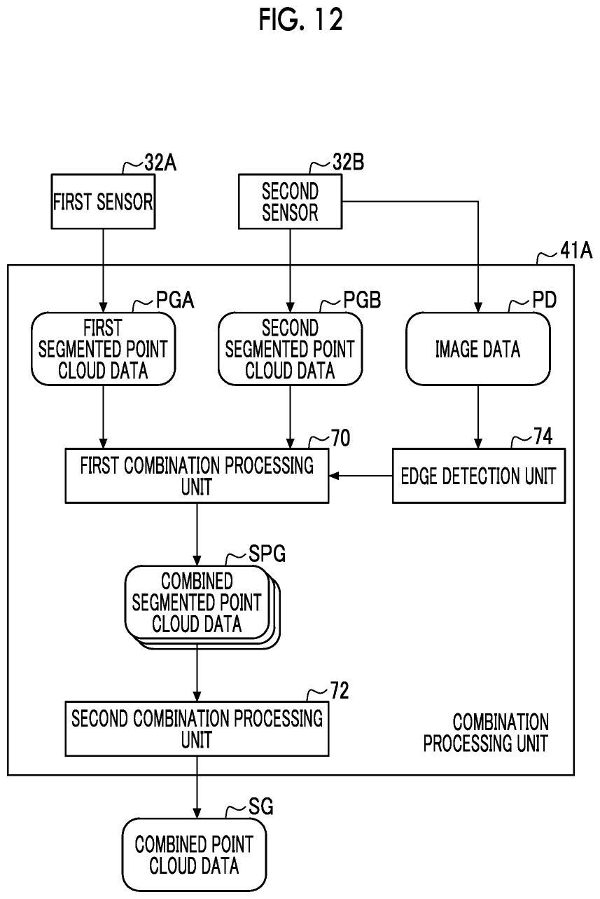

As shown in FIG. 12 as an example, in the present embodiment, a combination processing unit 41A that is realized by the CPU 40 is configured with a first combination processing unit 70, a second combination processing unit 72, and an edge detection unit 74. The first combination processing unit 70 acquires the first segmented point cloud data PGA and the second segmented point cloud data PGB output from the moving object 10A for each scan. The edge detection unit 74 acquires a plurality of pieces of image data PD output from the moving object 10A for each scan.

The first combination processing unit 70 generates combined segmented point cloud data SPG by partially selecting data from each of the first segmented point cloud data PGA and the second segmented point cloud data PGB based on a feature of a structure shown in at least one piece of image data PD among a plurality of pieces of image data PD.

The edge detection unit 74 performs image analysis on at least one piece of image data PD among a plurality of pieces of image data PD acquired from the moving object 10A, thereby detecting an edge portion of a structure shown in the image data PD. In the edge detection, a method by filtering, a method using machine learning, or the like can be used.

In the present embodiment, the first combination processing unit 70 generates the combined segmented point cloud data SPG by partially selecting data from each of the first segmented point cloud data PGA and the second segmented point cloud data PGB based on region information of the edge portion of the structure detected by the edge detection unit 74. The generation of the combined segmented point cloud data SPG by the first combination processing unit 70 is performed for each scan described above.

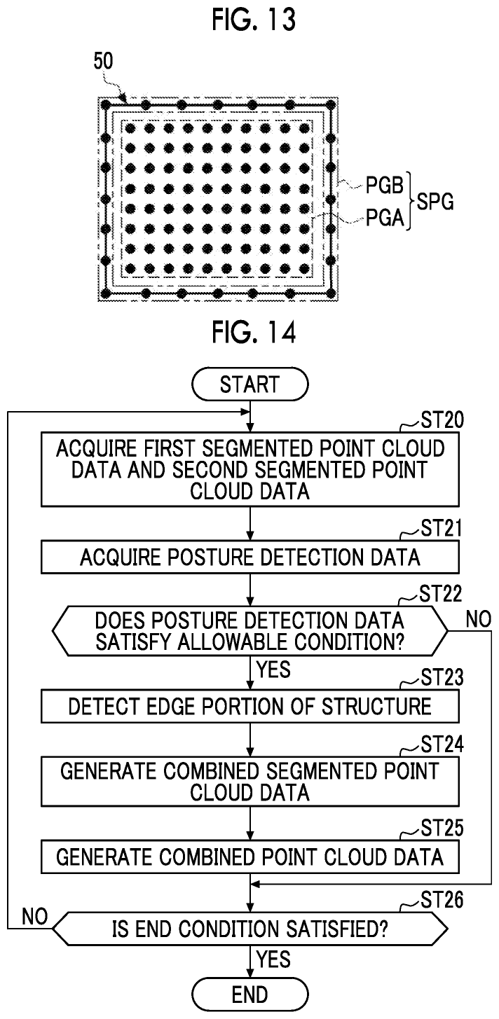

As shown in FIG. 13 as an example, the first combination processing unit 70 generates the combined segmented point cloud data SPG by selecting data corresponding to an edge portion of a structure 50 from the second segmented point cloud data PGB, selecting data corresponding to portions other than the edge portion of the structure 50 from the first segmented point cloud data PGA, and combining the selected data. That is, the combined segmented point cloud data SPG is high-definition segmented point cloud data in which the edge portion of the structure 50 in the first segmented point cloud data PGA is complemented by the second segmented point cloud data PGB.

The second combination processing unit 72 generates combined point cloud data SG by combining a plurality of pieces of combined segmented point cloud data SPG generated by the first combination processing unit 70. The combined point cloud data SG generated by the second combination processing unit 72 corresponds to the combined point cloud data SG of the first embodiment.

The combination processing unit 41A may execute the above-described combination processing after a plurality of pieces of first segmented point cloud data PGA and second segmented point cloud data PGB are acquired from the moving object 10A, or may execute the combination processing each time a set of first segmented point cloud data PGA and second segmented point cloud data PGB is acquired from the moving object 10A.

Next, operations of the moving object system 2A according to the second embodiment will be described with reference to FIG. 14.

FIG. 14 is a flowchart illustrating an example of a flow of the combination processing that is executed by the combination processing unit 41A. The flow of the combination processing shown in FIG. 14 is an example of an “information processing method” according to the technique of the present disclosure.

FIG. 14 shows an example where the combination processing unit 41A executes the combination processing each time the first segmented point cloud data PGA and the second segmented point cloud data PGB are acquired from the moving object 10A. Here, it is a prerequisite that the moving object 10A repeatedly scans the surrounding space using the external sensor 32 and outputs the first segmented point cloud data PGA and the second segmented point cloud data PGB to the information processing apparatus 20 for each scan.

In the combination processing shown in FIG. 14, first, in Step ST20, the combination processing unit 41A acquires the first segmented point cloud data PGA and the second segmented point cloud data PGB output from the moving object 10A. In Step ST20, the combination processing unit 41A acquires a plurality of pieces of image data PD output from the moving object 10A, in addition to the first segmented point cloud data PGA and the second segmented point cloud data PGB. After Step ST20, the combination processing proceeds to Step ST21.

In Step ST21, the combination processing unit 41A acquires the above-described posture detection data corresponding to the first segmented point cloud data PGA and the second segmented point cloud data PGB acquired in Step ST20, from the moving object 10A. After Step ST21, the combination processing proceeds to Step ST22.

In Step ST22, the combination processing unit 41A determines whether or not the posture detection data acquired in Step ST21 satisfies the above-described allowable condition. In Step ST22, in a case where the posture detection data satisfies the allowable condition, an affirmative determination is made, and the combination processing proceeds to Step ST23. In Step ST22, in a case where the posture detection data does not satisfy the allowable condition, a negative determination is made, and the combination processing proceeds to Step ST26.

In Step ST23, the edge detection unit 74 detects the edge portion of the structure shown in the image data PD based on at least one piece of image data PD. After Step ST23, the combination processing proceeds to Step ST24.

In Step ST24, as described above, the first combination processing unit 70 generates the combined segmented point cloud data SPG by combining the first segmented point cloud data PGA and the second segmented point cloud data PGB based on the region information of the edge portion of the structure detected by the edge detection unit 74. After Step ST24, the combination processing proceeds to Step ST25.

In Step ST25, the second combination processing unit 72 executes the above-described combination processing. Specifically, the first combination processing unit 70 generates the combined point cloud data SG by combining the combined segmented point cloud data SPG generated in a previous cycle and the combined segmented point cloud data SPG generated in a present cycle. After Step ST25, the combination processing proceeds to Step ST26.

In Step ST26, the combination processing unit 41A determines whether or not an end condition for ending the combination processing is satisfied. An example of the end condition is a condition that an instruction to end the combination processing is received by the reception device 22. In Step ST26, in a case where the end condition is not satisfied, the negative determination is made, and the combination processing proceeds to Step ST20. In Step ST26, in a case where the end condition is satisfied, the affirmative determination is made, and the combination processing ends.

As described above, in the second embodiment, the information processing apparatus 20 generates the combined segmented point cloud data SPG by combining the first segmented point cloud data PGA and the second segmented point cloud data PGB, and generates the combined point cloud data SG by further combining a plurality of pieces of combined segmented point cloud data SPG. Thus, high-definition combined point cloud data representing an environmental map is obtained.

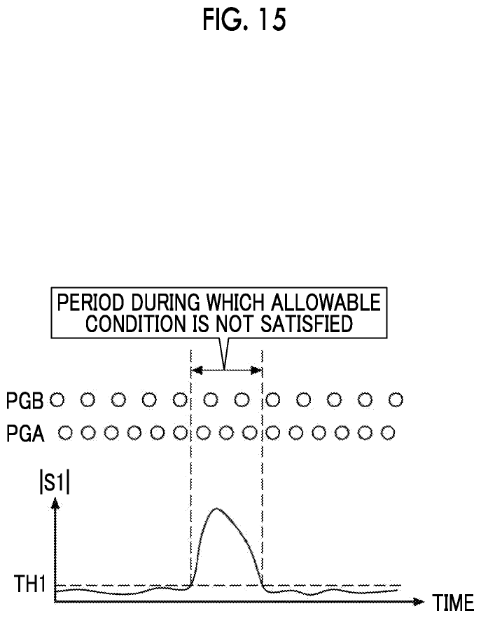

In the second embodiment, it is a prerequisite that the moving object 10A outputs the first segmented point cloud data PGA and the second segmented point cloud data PGB for each scan (that is, in the same period). Alternatively, as shown in FIG. 15, the moving object 10A may output the first segmented point cloud data PGA and the second segmented point cloud data PGB in different periods. Even in this case, the combination processing is executed using the first segmented point cloud data PGA and the second segmented point cloud data PGB acquired in a period during which the posture detection data satisfies the allowable condition. In this case, the second combination processing unit 72 may generate the combined segmented point cloud data SPG by combining the first segmented point cloud data PGA and the second segmented point cloud data PGB closest temporally.

In the second embodiment, although a plurality of cameras 60 are provided in the measurement apparatus 30A, only one camera 60 may be provided in the measurement apparatus 30A. Even in a case where only one camera 60 is provided in the measurement apparatus 30A, because the moving object 10A is moving, two pieces of image data PD at different imaging times have different viewpoints. For this reason, the second sensor 32B can generate the second segmented point cloud data PGB based on two pieces of image data PD at different imaging times.

In the above-described first and second embodiments, although the program 43 for combination processing is stored in the NVM 42 (see FIGS. 3 and 10), the technique of the present disclosure is not limited thereto, and the program 43 may be stored in a non-transitory storage medium, such as an SSD or a USB memory. In this case, the program 43 stored in the non-transitory storage medium is installed on the information processing apparatus 20 as a computer, and the CPU 40 executes the above-described combination processing according to the program 43.

Alternatively, the program 43 may be stored in a storage device of another computer, a server apparatus, or the like connected to the information processing apparatus 20 via a communication network (not shown), and the program 43 may be downloaded to and installed on the information processing apparatus 20 according to a request of the information processing apparatus 20. In this case, the combination processing is executed by the computer according to the installed program 43.

In the above-described first and second embodiments, although the combination processing is executed in the information processing apparatus 20, a configuration may be made in which the combination processing may be executed in the moving object 10, 10A.

As a hardware resource for executing the above-described combination processing, various processors described below can be used. Examples of the processors include a CPU that is a general-purpose processor configured to execute software, that is, the program 43 to function as the hardware resource for executing the combination processing as described above. Examples of the processors include a dedicated electric circuit that is a processor, such as an FPGA, a PLD, or an ASIC, having a circuit configuration dedicatedly designed for executing specific processing. Any processor has a memory built in or connected to it, and any processor uses the memory to execute the combination processing.

The hardware resource for executing the combination processing may be configured with one of various processors or may be configured with a combination of two or more processors (for example, a combination of a plurality of FPGAs or a combination of a CPU and an FPGA) of the same type or different types. The hardware resource for executing the combination processing may be one processor.

As an example where the hardware resource is configured with one processor, first, as represented by a computer, such as a client and a server, there is a form in which one processor is configured with a combination of one or more CPUs and software, and the processor functions as the hardware resource for executing the combination processing. Second, as represented by an SoC or the like, there is a form in which a processor that realizes the functions of the entire system including a plurality of hardware resources for executing the combination processing into one IC chip is used. In this way, the combination processing is realized using one or more processors among various processors described above as the hardware resource.

As the hardware structures of various processors, more specifically, an electric circuit in which circuit elements, such as semiconductor elements, are combined can be used.

The above-described combination processing is merely an example. Accordingly, it goes without saying that unnecessary steps may be deleted, new steps may be added, or a processing order may be changed without departing from the gist.

The content of the above description and the content of the drawings are detailed description of portions according to the technique of the present disclosure, and are merely examples of the technique of the present disclosure. For example, the above description relating to configurations, functions, operations, and advantageous effects is description relating to an example of configurations, functions, operations, and advantageous effects of the portions according to the technique of the present disclosure. Thus, it goes without saying that unnecessary portions may be deleted, new elements may be added, or replacement may be made to the content of the above description and the content of the drawings without departing from the gist of the technique of the present disclosure. Furthermore, to avoid confusion and to facilitate understanding of the portions according to the technique of the present disclosure, description relating to common technical knowledge and the like that does not require particular description to enable implementation of the technique of the present disclosure is omitted from the content of the above description and from the content of the drawings.

In the specification, “A and/or B” is synonymous with “at least one of A or B”. That is, “A and/or B” may refer to A alone, B alone, or a combination of A and B. Furthermore, in the specification, a similar concept to “A and/or B” applies to a case in which three or more matters are expressed by linking the matters with “and/or”.

All cited documents, patent applications, and technical standards described in the specification are incorporated by reference in the specification to the same extent as in a case where each individual cited document, patent application, or technical standard is specifically and individually indicated to be incorporated by reference.

The following technique can be ascertained by the above description.

[Supplementary Item 1]

An information processing apparatus that processes segmented point cloud data output from a measurement apparatus including an external sensor that repeatedly scans a surrounding space to acquire the segmented point cloud data for each scan, and an internal sensor that detects a posture to acquire posture detection data, the information processing apparatus comprising:
at least one processor,
in which the processor is configured to:
generate combined point cloud data by executing combination processing using a plurality of pieces of the segmented point cloud data acquired in a period during which the posture detection data satisfies an allowable condition, among a plurality of pieces of the segmented point cloud data acquired at different acquisition times by the external sensor.

[Supplementary Item 2]

The information processing apparatus according to Supplementary Item 1,
in which the internal sensor is an inertial measurement sensor having at least one of an acceleration sensor or an angular velocity sensor, and
the posture detection data includes an output value of the acceleration sensor or of the angular velocity sensor.

[Supplementary Item 3]

The information processing apparatus according to Supplementary Item 2,
in which the allowable condition is that an absolute value of the output value of the acceleration sensor or of the angular velocity sensor is less than a first threshold value.

[Supplementary Item 4]

The information processing apparatus according to Supplementary Item 2,
in which the allowable condition is that a temporal change amount of the output value of the acceleration sensor or of the angular velocity sensor is less than a second threshold value.

[Supplementary Item 5]

The information processing apparatus according to any one of Supplementary Item 1 to Supplementary Item 4,
in which the external sensor includes a first sensor that acquires first segmented point cloud data by scanning a space with laser light, and a second sensor that acquires second segmented point cloud data based on a plurality of camera images, and
the segmented point cloud data includes the first segmented point cloud data and the second segmented point cloud data.

[Supplementary Item 6]

The information processing apparatus according to Supplementary Item 5,
in which the processor is configured to:
generate combined segmented point cloud data by combining the first segmented point cloud data and the second segmented point cloud data, and generate the combined point cloud data by combining a plurality of pieces of the generated combined segmented point cloud data.

[Supplementary Item 7]

The information processing apparatus according to Supplementary Item 6,
in which the processor is configured to:
generate the combined segmented point cloud data by partially selecting data from each of the first segmented point cloud data and the second segmented point cloud data based on a feature of a structure shown in at least one camera image among the plurality of camera images.

[Supplementary Item 8]

The information processing apparatus according to any one of Supplementary Item 1 to Supplementary Item 7,
in which the measurement apparatus is provided in an unmanned moving object.

[Supplementary Item 9]

An information processing method that processes segmented point cloud data output from a measurement apparatus including an external sensor that repeatedly scans a surrounding space to acquire the segmented point cloud data for each scan, and an internal sensor that detects a posture to acquire posture detection data, the information processing method comprising:
generating combined point cloud data by executing combination processing using a plurality of pieces of the segmented point cloud data acquired in a period during which the posture detection data satisfies an allowable condition, among a plurality of pieces of the segmented point cloud data acquired at different acquisition times by the external sensor.

[Supplementary Item 10]

A program that causes a computer to execute processing on segmented point cloud data output from a measurement apparatus including an external sensor that repeatedly scans a surrounding space to acquire the segmented point cloud data for each scan, and an internal sensor that detects a posture to acquire posture detection data, the program causing the computer to execute:
combination processing of generating combined point cloud data using a plurality of pieces of the segmented point cloud data acquired in a period during which the posture detection data satisfies an allowable condition, among a plurality of pieces of the segmented point cloud data acquired at different acquisition times by the external sensor.

What is claimed is:

1. An information processing apparatus that processes segmented point cloud data output from a measurement apparatus including an external sensor that includes a first sensor that acquires first segmented point cloud data by scanning laser light and a second sensor that acquires second segmented point cloud data based on a plurality of camera images, and repeatedly scans a surrounding space to acquire the segmented point cloud data, which includes the first segmented point cloud data and the second segmented point cloud data, for each scan, and an internal sensor that detects a posture to acquire posture detection data, the information processing apparatus comprising:
at least one processor,
wherein the processor is configured to:
generate combined point cloud data by executing combination processing using a plurality of pieces of the segmented point cloud data acquired in a period during which the posture detection data satisfies an allowable condition, among a plurality of pieces of the segmented point cloud data acquired at different acquisition times by the external sensor,
wherein the processor generates the combined segmented point cloud data by partially selecting data from each of the first segmented point cloud data and the second segmented point cloud data based on a feature of a structure shown in at least one camera image among the plurality of camera images, and generates the combined point cloud data by combining a plurality of pieces of the generated combined segmented point cloud data.

2. The information processing apparatus according to claim 1,
wherein the internal sensor is an inertial measurement sensor having at least one of an acceleration sensor or an angular velocity sensor, and
the posture detection data includes an output value of the acceleration sensor or of the angular velocity sensor.

3. The information processing apparatus according to claim 2,
wherein the allowable condition is that an absolute value of the output value of the acceleration sensor or of the angular velocity sensor is less than a first threshold value.

4. The information processing apparatus according to claim 2,
wherein the allowable condition is that a temporal change amount of the output value of the acceleration sensor or of the angular velocity sensor is less than a second threshold value.

5. The information processing apparatus according to claim 1,
wherein the processor detects an edge portion as the feature of the structure, selects data corresponding to the edge portion from the second segmented point cloud data, selects data corresponding to portions other than the edge portion from the first segmented point cloud data, and generates the combined point cloud data by combining the selected data.

6. The information processing apparatus according to claim 1,
wherein the measurement apparatus is provided in an unmanned moving object.

7. An information processing method that processes segmented point cloud data output from a measurement apparatus including an external sensor that includes a first sensor that acquires first segmented point cloud data by scanning laser light and a second sensor that acquires second segmented point cloud data based on a plurality of camera images, and repeatedly scans a surrounding space to acquire the segmented point cloud data, which includes the first segmented point cloud data and the second segmented point cloud data, for each scan, and an internal sensor that detects a posture to acquire posture detection data, the information processing method comprising:
generating combined point cloud data by executing combination processing using a plurality of pieces of the segmented point cloud data acquired in a period during which the posture detection data satisfies an allowable condition, among a plurality of pieces of the segmented point cloud data acquired at different acquisition times by the external sensor,
wherein the combined segmented point cloud data is generated by partially selecting data from each of the first segmented point cloud data and the second segmented point cloud data based on a feature of a structure shown in at least one camera image among the plurality of camera images, and the combined point cloud data is generated by combining a plurality of pieces of the generated combined segmented point cloud data.

8. A non-transitory computer-readable storage medium storing a program that causes a computer to execute processing on segmented point cloud data output from a measurement apparatus including an external sensor that includes a first sensor that acquires first segmented point cloud data by scanning laser light and a second sensor that acquires second segmented point cloud data based on a plurality of camera images, and repeatedly scans a surrounding space to acquire the segmented point cloud data, which includes the first segmented point cloud data and the second segmented point cloud data, for each scan, and an internal sensor that detects a posture to acquire posture detection data, the program causing the computer to execute:
combination processing of generating combined point cloud data using a plurality of pieces of the segmented point cloud data acquired in a period during which the posture detection data satisfies an allowable condition, among a plurality of pieces of the segmented point cloud data acquired at different acquisition times by the external sensor,
wherein the combined segmented point cloud data is generated by partially selecting data from each of the first segmented point cloud data and the second segmented point cloud data based on a feature of a structure shown in at least one camera image among the plurality of camera images, and the combined point cloud data is generated by combining a plurality of pieces of the generated combined segmented point cloud data.
